(19) United States
(12) Patent Application Publication
(10) Pub. No.: US 2015/0193327 A1
(43) Pub. Date: Jul. 9, 2015

(54) CONNECTION CHECKING FOR HARDWIRED MONITORING SYSTEM

(71) Applicant: Cinch Systems, Inc., St Michael, MN (US)

(72) Inventors: Joel Curtis Christianson, Corcoran, MN (US); Gregory Brett Olson, Woodbury, MN (US)

(73) Assignee: Cinch Systems, Inc., St. Michael, MN (US)

(21) Appl. No.: 14/151,661

(22) Filed: Jan. 9, 2014

(51) Int. Cl. G06F 11/34; G06F 11/32; G06F 11/30

(52) U.S. Cl. CPC G06F 11/3495; G06F 11/3006; G06F 11/321

(57) ABSTRACT

A system includes a controller, a hardwired network coupled to the controller, a plurality of devices coupled to the network via drops between connectors to the network and connectors to the devices, and wherein the controller performs performance monitoring of communications between the controller and the devices to identify devices which are improperly connected to the serial bus.

### BACKGROUND

Hardwired security systems may suffer communications problems due to faulty wiring during or after installation. Wires can be knocked loose at any time during installation or operation, and it can be difficult to trace such problems in current systems.

### SUMMARY

A system includes a controller, a hardwired network coupled to the controller, a plurality of devices coupled to the network via drops between connectors to the network and connectors to the devices, and wherein the controller performs performance monitoring of communications between the controller and the devices to identify devices which are improperly connected to the serial bus.

A method including performing performance monitoring of a hardwired network via a processor coupled to the hardwired network, identifying devices that are not communicating properly, and providing an identification of the identified devices to a network installer to facilitate identification and fixing of connections to the identified devices.

A machine readable storage device having instructions for execution by a processor of the machine to perform a method including performing performance monitoring of a hardwired network via a processor coupled to the hardwired network, identifying devices that are not communicating properly, and providing an identification of the identified devices to a network installer to facilitate identification and fixing of connections to the identified devices.

### BRIEF DESCRIPTION OF THE DRAWINGS

FIG. 1 is a block diagram of a hardwired network with multiple devices according to an example embodiment.

FIG. 2 is a flowchart illustrating a method of identifying faulty connections in a hardwired network according to an example embodiment.

FIG. 3 is a block diagram of a computer system for implementing a controller and methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

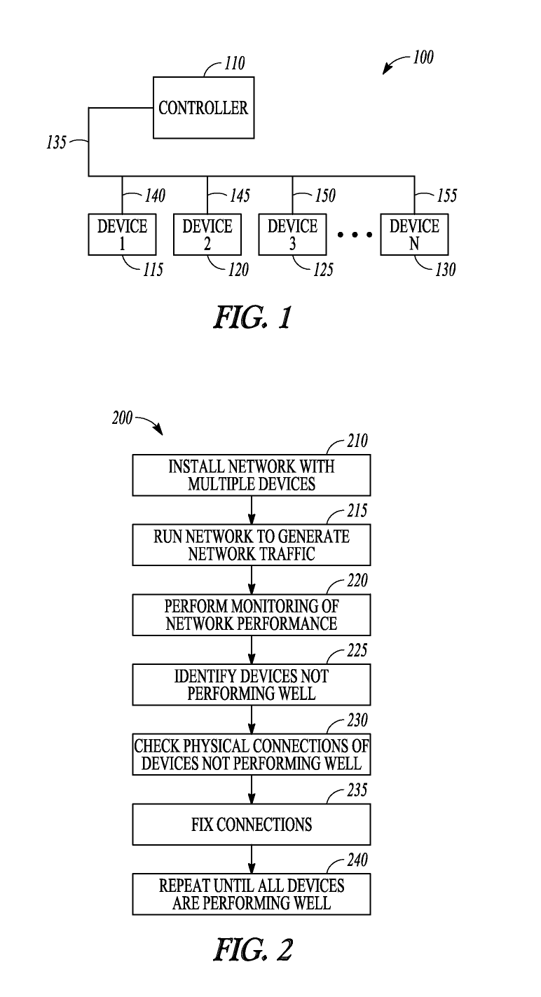

FIG. 1 is a block diagram of a hardwired network 100. Network 100 includes a controller 110 and multiple devices 115, 120, 125, 130 coupled to the controller 110 by a hardwired network 135. In one embodiment, the hardwired network 135 operates in accordance with an RS485 LAN physical specification. Network 135 in one embodiment is a linear multi-drop configuration and may utilize two wires. Each device 115, 120, 125, 130 is coupled to the network 135 by corresponding drops or wires 140, 145, 150, 155 connected directly to the devices via connectors. Each drop has a connection to the network 135 and a connection to the device. Any one of the connectors or wires may become loose or may be defective, causing a degradation of communications with one or more devices. In various embodiments, the system 100 may include security systems, fire detection systems, life safety sector systems and others.

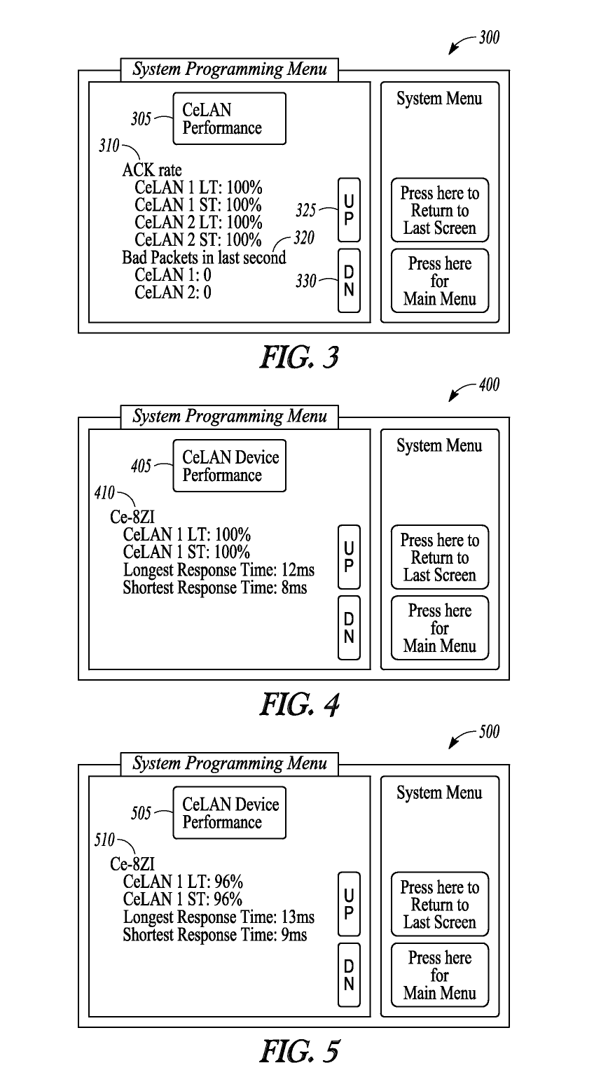

FIG. 2 is a flowchart illustrating one example method 200 of identifying faulty connections in hardwired network 135. The method 200 may be performed by the controller or other device capable of monitoring communications on network 135. At 210, a network is installed with multiple devices. In one embodiment, a single device may be replaced or added. Such a device may be referred to as an expansion device. At 215, the network is run to generate network traffic. A test mode may be optionally used in one embodiment. The network traffic may utilize different communication protocols as desired, and should be generated to and from each connected device such that each device receives and responds to information communicated via the network. A network performance monitoring application is run at 220 to monitor the performance of the network. The application may track communications successfully received and sent from each device. In some embodiments, the application may monitor the speed at which devices respond, the number of retransmissions needed for successful communication, the accuracy of data sent as verified by checksums or error correction codes, and other known performance monitoring metrics. In a further embodiment, a simple log of communications may be recorded. The application may run on controller 110 or other device capable of monitoring network performance with respect to each device.

The performance of each device is monitored and may be displayed at 225, wherein devices not performing well are identified, such as by device ID or user name given for each device. Devices that are not performing within desired parameters, such as a set number of errors per communication, may be highlighted or otherwise identified on a display or list of devices. In further embodiments, the recorded log of communications may simply be provided to an installer for visual inspection. The log may contain a device identifier for each communication and an indication of the status of the communication with the device. The errors may be caused by poor connections, noise, or other common or uncommon problems in connecting devices to the network. Such identified devices may pin pointed by the monitoring and then may be inspected at 230 by checking physical connections of the devices. The connections may be fixed at 235 by either removing and replacing the wires, or perhaps noting if a connector is defective either at the device or at the wire 135. Method 200 may be repeated from 215 as many times as needed to ensure that the network is operating properly and that all connections to devices are sound.

In some embodiments, since connections may also degrade over time the system provides a rolling continuous monitoring of each device performance by measuring the number of missed direct communications out of the last 100, 1000, or say 10,000 attempts. For example in some embodiments, control boards may be mounted to a unit that vibrates when it is in operation. The vibrations can shake connections loose over time. In a continuous loop implementation, elements 215, 225, and 230 may be continuously performed, with fixing connection occurring as faulty connections are identified.

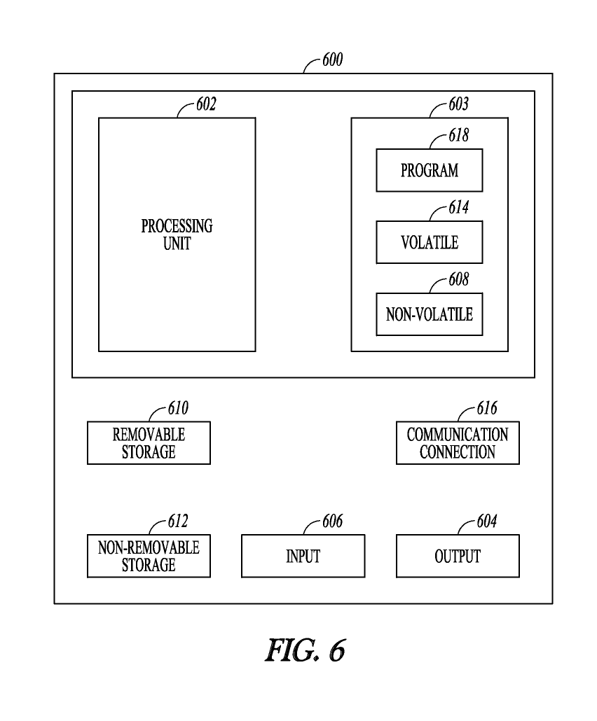

A displayable menu 300 is illustrated in a block screen diagram of FIG. 3. The menu 300 includes information regarding network performance, labeled CeLAN performance at 305. CeLAN refers to an encrypted local area network in one embodiment, but may be unencrypted in some embodiments. Information regarding the network performance is indicated at 310 with acknowledgement rates identified for both long term (LT) and short term (ST) periods. Short term in one embodiment corresponds to 100 or so samples of performance, with long term corresponding to more samples. At 320, bad packets for each of two networks in a system are summarized. In this example screen, the information indicates 100% acknowledgment rate for each network with no bad packets in the last second. Navigation buttons allow a user to navigate up at 325, down at 330, return to last screen at 335 and return to a main menu at 340. FIG. 4 is a block diagram illustrating a screen menu 400 showing the performance of a device 405 in monitored network communications. A device Ce-8ZI is indicated at 410 with associated LT and ST performance of 100%. A longest response time is identified as 12 ms and a shortest response time of 8 ms is illustrated. Navigation buttons similar to those on menu 300 are provided.

FIG. 5 is a block diagram illustrating a screen menu 500 showing the performance of a device 505 in monitored network communications. In menu 500, the performance of the device is indicative of a potential connection problem. Device Ce-8ZI is indicated at 510 with associated LT and ST performance of 96%. A longest response time is identified as 13 ms and a shortest response time of 9 ms is illustrated. Navigation buttons similar to those on menu 300 are provided.

Different performance thresholds may be utilized in various embodiments. In some embodiments, performance under 100% may be considered as indicative of a problem worth checking for faulty or soon to fail connections. In some embodiments, any performance of 96% or less may give rise to such an indication. In still further embodiments, performance below 90% requires investigation. In still further embodiments, empirical data may be used to set thresholds, as length of network wires may play a role in performance data. For instance, a longer length wire may give rise to lower performance and more bad packets, resulting in a lower percentage threshold being indicative of a potential loose connection.

FIG. 6 is a block diagram of a computer system for implementing a controller and methods according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 600, may include a processing unit 602, memory 603, removable storage 610, and non-removable storage 612. Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 600 may include or have access to a computing environment that includes input 606, output 604, and a communication connection 616. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 600. A hard drive, CD-ROM, and RAM are some examples of articles including a non-transitory computer-readable medium. For example, a computer program 618 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 600 to provide generic access controls in a COM based computer network system having multiple users and servers.

### EXAMPLES

1. A system comprising:

a controller;

a hardwired network coupled to the controller;

a plurality of devices coupled to the network via drops between connectors to the network and connectors to the devices; and wherein the controller performs performance monitoring of communications between the controller and the devices to identify devices which are improperly connected to the serial bus.

2. The system of example 1 wherein the network comprises a two wire bus.

3. The system of any of examples 1-2 wherein the controller comprises a processor and software stored on a computer readable storage device to cause the processor to perform the performance monitoring.

4. The system of any of examples 1-3 and further comprising a monitor to display the identified devices which are improperly connected to the network.

5. A method comprising:

performing performance monitoring of a hardwired network via a processor coupled to the hardwired network;

identifying devices that are not communicating properly; and

providing an identification of the identified devices to a network installer to facilitate identification and fixing of connections to the identified devices.

6. The method of example 5 and further comprising repeating the elements of example 5 following fixing of connections to the identified devices.

7. The method of any of examples 5-6 wherein the identification of the identified devices is performed on a display device.

8. The method of any of examples 5-7 wherein identifying devices that are not communicating properly comprises keeping a log of communications.

9. The method of example 8 wherein providing an identification of the identified devices to a network installer comprises providing a display of the log.

10. The method of any of examples 5-9 wherein the hardwired network is a two wire serial bus and the devices are coupled to the network via drops with connectors to the two wire serial bus and to the devices.

11. The method of any of examples 5-10 wherein the processor performs the method by executing software stored on a computer readable storage device.

12. A machine readable storage device having instructions for execution by a processor of the machine to perform a method comprising:

performing performance monitoring of a hardwired network via a processor coupled to the hardwired network;

identifying devices that are not communicating properly; and

providing an identification of the identified devices to a network installer to facilitate identification and fixing of connections to the identified devices.

13. The machine readable storage device of example 12, wherein the method further comprises repeating the elements of performing, identifying, and providing following fixing of connections to the identified devices.

14. The machine readable storage device of any of examples 12-13 wherein the identification of the identified devices is performed on a display device.

15. The machine readable storage device of any of examples 12-14 wherein the hardwired network is a two wire serial bus and the devices are coupled to the network via drops with connectors to the two wire serial bus and to the devices.

16. A system comprising:

a processor; and

a memory device coupled to the processor and having a program stored thereon for execution by the processor to:

perform performance monitoring of a hardwired network via a processor coupled to the hardwired network;

identify devices that are not communicating properly; and

provide an identification of the identified devices to a network installer to facilitate identification and fixing of connections to the identified devices.

17. The system of example 16 wherein the program executed by the processor further generates a menu for display of network performance.

18. The system of example 17 wherein the menu includes acknowledgement rate and back packet counts for the network.

19. The system of any of examples 17-18 wherein the menu includes long term and short term performance metrics for a device coupled to the network.

20. The system of example 19 wherein the menu includes longest and shortest response times for the device.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system comprising:
a controller;
a hardwired network coupled to the controller;
a plurality of devices coupled to the network via drops between connectors to the network and connectors to the devices; and
wherein the controller performs performance monitoring of communications between the controller and the devices to identify devices which are improperly connected to the serial bus.

2. The system of claim 1 wherein the network comprises a two wire bus.

3. The system of claim 1 wherein the controller comprises a processor and software stored on a computer readable storage device to cause the processor to perform the performance monitoring.

4. The system of claim 1 and further comprising a monitor to display the identified devices which are improperly connected to the network.

5. A method comprising:
performing performance monitoring of a hardwired network via a processor coupled to the hardwired network;
identifying devices that are not communicating properly; and
providing an identification of the identified devices to a network installer to facilitate identification and fixing of connections to the identified devices.

6. The method of claim 5 and further comprising repeating the elements of claim 5 following fixing of connections to the identified devices.

7. The method of claim 5 wherein the identification of the identified devices is performed on a display device.

8. The method of claim 5 wherein identifying devices that are not communicating properly comprises keeping a log of communications.

9. The method of claim 8 wherein providing an identification of the identified devices to a network installer comprises providing a display of the log.

10. The method of claim 5 wherein the hardwired network is a two wire serial bus and the devices are coupled to the network via drops with connectors to the two wire serial bus and to the devices.

11. The method of claim 5 wherein the processor performs the method by executing software stored on a computer readable storage device.

12. A machine readable storage device having instructions for execution by a processor of the machine to perform a method comprising:
performing performance monitoring of a hardwired network via a processor coupled to the hardwired network;
identifying devices that are not communicating properly; and
providing an identification of the identified devices to a network installer to facilitate identification and fixing of connections to the identified devices.

13. The machine readable storage device of claim 12, wherein the method further comprises repeating the elements of performing, identifying, and providing following fixing of connections to the identified devices.

14. The machine readable storage device of claim 12 wherein the identification of the identified devices is performed on a display device.

15. The machine readable storage device of claim 12 wherein the hardwired network is a two wire serial bus and the devices are coupled to the network via drops with connectors to the two wire serial bus and to the devices.

16. A system comprising:
a processor; and
a memory device coupled to the processor and having a program stored thereon for execution by the processor to:
perform performance monitoring of a hardwired network via a processor coupled to the hardwired network;
identify devices that are not communicating properly; and
provide an identification of the identified devices to a network installer to facilitate identification and fixing of connections to the identified devices.

17. The system of claim 16 wherein the program executed by the processor further generates a menu for display of network performance.

18. The system of claim 17 wherein the menu includes acknowledgement rate and back packet counts for the network.

19. The system of claim 17 wherein the menu includes long term and short term performance metrics for a device coupled to the network.

20. The system of claim 19 wherein the menu includes longest and shortest response times for the device.
